(19) United States
(12) Patent Application Publication
(10) Pub. No.: US 2026/0313769 A1
(43) Pub. Date: Oct. 8, 2026

(54) CIRCUIT FOR DRIVING A LED STRING

(71) Applicant: ams-OSRAM International GmbH, Regensburg (DE)

(72) Inventors: Thomas TROXLER, Uerikon (CH); Matteo COLOMBO, Verrua Po (IT)

(21) Appl. No.: 19/482,236

(22) PCT Filed: Oct. 25, 2024
(86) PCT No.: PCT/EP2024/080229

§ 371 Date: Nov. 7, 2025

(30) Foreign Application Priority Data
Nov. 21, 2023 (DE) 10 2023 132 441.1

(51) Int. Cl. H05B 45/48; H05B 45/10; H05B 45/325

(52) U.S. Cl. CPC H05B 45/48; H05B 45/10; H05B 45/325

(57) ABSTRACT

The present disclosure relates to a circuit including: a plurality of voltage sources, each configured to generate a respective voltage; a plurality of voltage rails, each coupled with a respective voltage source; a plurality of strings of LED devices, wherein each string comprises a plurality of LED devices connected in series; a switch circuit configured to selectively couple or decouple each string with the voltage rails, wherein, for each string of LED devices, the switch circuit is configured to allow a simultaneous coupling of the string with each voltage rail; and a control circuit configured to, for each string of LED devices, control the switch circuit to selectively couple the string with one or more voltage rails.

### TECHNICAL FIELD

The present disclosure relates generally to a circuit with an adapted configuration for driving a string of light emitting diodes, and to methods thereof (e.g., a method of driving a string of light emitting diodes).

### BACKGROUND

In general, lighting fixtures and display devices are present in a wide range of technical contexts and applications, e.g. for headlights of a vehicle, for illuminating an environment, for displaying images, and the like. In this context, light emitting diodes (LEDs) are widely adopted in view of their attractive properties, such as a relatively long lifetime, an energy-efficient operation, almost no heat emission, the capability of withstanding fast switching, flexibility in the design, dimming capabilities, and the like. LEDs are applied in many different scenarios, e.g. in displays such as in televisions or smartphones, in lighting fixtures for interior illumination to exploit the dimming capabilities, in optical communication systems, etc. A particularly interesting application of LED devices is in the automotive context. In this application scenario, LEDs may be used as light fixtures for illuminating the interior of a vehicle, as part of a headlight of a vehicle, as part of a pattern projection system, and the like. In this context, a pixelated light source including a plurality of LEDs as pixels provides an efficient and flexible solution for generating light beams with an adaptable shape, e.g. to assist the driver of a vehicle with a suitable illumination for the current driving conditions. Individual LEDs or groups of LEDs in the pixelated light source may be controlled, e.g. turned on, turned off, or dimmed, to obtain the desired light beam. Improvements in circuit architectures for driving LEDs may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows a light fixture including a plurality of LED devices configured according to a direct drive approach, in a schematic representation according to various aspects;

FIG. 1B shows a light fixture including a plurality of strings of LED devices, in a schematic representation according to various aspects;

FIG. 2A shows an adapted circuit architecture for driving a LED string, in a schematic representation according to various aspects;

FIG. 2B shows an adapted circuit architecture for driving a plurality of LED strings, in a schematic representation according to various aspects;

FIG. 3 shows an exemplary configuration of a driver circuit, in a schematic representation according to various aspects;

FIG. 4 shows an exemplary configuration of the switch circuit of the adapted circuit architecture for driving a LED string, in a schematic representation according to various aspects;

FIG. 5 shows a control of the current source of the adapted circuit architecture via a PWM signal, in a schematic representation according to various aspects; and

FIG. 6 shows a schematic flow diagram of a method of driving a string of LED devices, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a circuit, a light emitting diode). However, it is understood that aspects described in connection with methods may similarly apply to the devices, and vice versa.

In general, a light emitting diode (LED) is a solid-state device that emits light when an electric current flows through it. A LED is semiconductor-based device, and the type of semiconductor used for fabricating the LED defines the color of the emitted light. Common examples of semiconductor materials for LED devices include gallium phosphide (GaP) for emission of yellow and green light, aluminum gallium indium phosphide (AlGaInP) for emission of orange and red light, indium gallium nitride (InGaN) for emission of blue, green and ultraviolet light, and aluminum gallium arsenide (AlGaAs) for emission of red and infrared light.

LED devices present several advantageous properties that make them particularly attractive for applications in many different scenarios. In the recent years, LED devices gained increasing interest for applications in the automotive context. For example, LEDs are particularly suitable for use in the headlight of a vehicle. A pixelated light including a large number of LED pixels may enable a flexible adaptation of the light beam that is output from the headlight, e.g. to generate a high beam, a low beam, or any suitable profile for the driving scenario. The flexible illumination ensured by LED pixels enhances the safety of the driver, e.g. by providing stronger illumination towards potentially dangerous road features, by providing stronger illumination of traffic signs, by dimming the illumination when another vehicle is approaching, etc.

Another exemplary application of LED devices in the automotive context is for pattern projection. A projection system may be integrated, for example, in the door of a vehicle or in the headlight of the vehicle. A common use of such projection systems is the creation of “welcome light carpets”, in which a cosmetic pattern is projected in the vicinity of the vehicle, e.g. including the brand of the vehicle's manufacturer, or a welcome message for the driver. Another example is the projection of information on an interior surface of the vehicle or in the vicinity of the vehicle, e.g. a warning symbol for the driver, or a warning symbol for the neighboring vehicles or for cyclists. Other application scenarios of projection systems may include industrial environments, e.g. to assist robots or drones within a factory, home environments, e.g. to project cosmetic light features, and the like.

In this context, there is a constant trend towards increasing the number of pixels in a light fixtures, e.g. the number of LED pixels in the headlight of a vehicle. Illustratively, increasing the number of pixels increases the possibilities for tailoring the emitted light beam by selecting how many pixels to activate, by selecting the brightness of the emitted light, by selecting the colors to be combined, etc. As a numerical example, the headlight of a vehicle may include in general about one hundred pixels, but the current trends aim to integrate tens of thousands (e.g., 20000) pixels. In this scenario, the power consumption of such arrangements becomes a more and more relevant factor for a sustainable operation of the lighting fixtures, in particular for use in electric vehicles. Furthermore, increasing the number of pixels may also lead to an increased heat dissipation of the arrangement during operation.

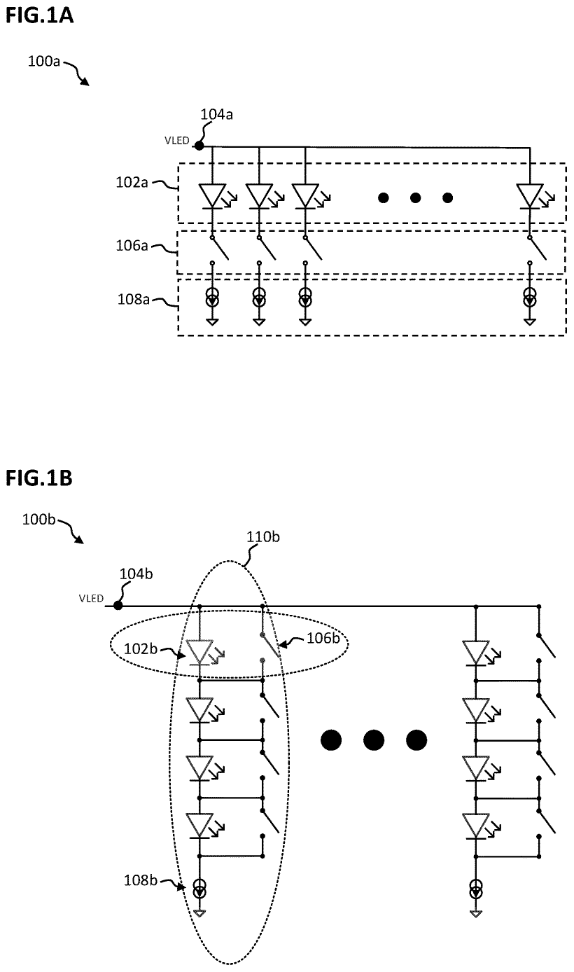

FIG. 1A and FIG. 1B show two possible circuit architectures for driving the light emission of LED devices. FIG. 1A shows a first circuit configuration 100a based on a “direct drive approach”, and FIG. 1B shows a second configuration 100b in which the LEDs are arranged in strings.

As shown in FIG. 1A, in a circuit configuration 100a according to the “direct drive approach”, each light emitting diode 102a may have a corresponding current source 108a. In this configuration, the circuit 100a may include a supply terminal 104a at which the circuit 100a receives a supply voltage VLED, and the circuit 100a may further include a plurality of LEDs 102a coupled in parallel with one another. The LEDs 102a may be coupled between the supply terminal 104a and ground, such that the supply voltage VLED defines the voltage drop across each of the LEDs 102a. The circuit 100a may further include a switchable element 106a for each LED 102a, to selectively enable or disable the flow of current through the LED 102a.

Illustratively, the switchable element 106a associated with a LED 102a may be connected in series between the LED 102a and the corresponding current source 108a, and may be configured to selectively connect or disconnect a conductive path between the LED 102a and the corresponding current source 108a. When the path is connected (in other words, closed), the current source 108a may draw current from the supply and cause light emission from the LED 102a. Although not show, the circuit 100a may further include a control circuit configured to control the switchable elements 106a to obtain a desired light output from the plurality of LEDs 102a.

The configuration in FIG. 1A enables a fine control of the light emission by the plurality of LEDs 102a, by allowing the individual control of each LED 102a. However, the configuration in FIG. 1A may have severe drawbacks in terms of power consumption and power losses. As shown, each LED has a driver, and each driver may be designed with certain headroom, so that in general about 30% of the power may be lost. The efficiency of the configuration in FIG. 1A may thus be limited in applications that require large number of LEDs 102a.

The circuit configuration 100b in FIG. 1B addresses some of the issues of the direct drive approach by grouping LEDs 102b together in so-called “strings”. As shown, the circuit 100b may include a plurality of LED strings 110b, and each string 100b may include a plurality of LEDs 102b and a (single) current source 108b for the string 100b. The LED strings 110b may be coupled in parallel with one another, and may be coupled between the supply terminal 104b and ground, such that the supply voltage VLED defines the voltage drop across each of the LED strings 110b. Each string 110b may include a plurality of LEDs 102b connected in series, and a switchable element 106b for each LED 102b.

The switchable elements 106b may be configured as bypass switches (also referred to herein as short switches) configured to selectively enable or disable the flow of current through the corresponding LED 102b by selectively disconnecting (opening) or connecting (closing) a conductive path through which the current may bypass the LED 102b. In the configuration in FIG. 1B the LEDs 102b may thus be stacked in series, and the bypassing of some LEDs 102b may allow to save power. Further, a single current source 108b is used for a plurality of stacked LEDs 102b, thus providing a simpler configuration.

The circuit configuration 100b is widely adopted for pixelated lights with a low pixel count, e.g. maximum one hundred pixels. In particular, this configuration works efficiently if each LED 102b in a string 110b is on to emit light. However, if one or more LEDs 102b in a string 110b are off (bypassed), the remaining power is across the current source 108b. Illustratively, the supply voltage 104b defines a voltage drop across the string 110b to allow light emission by each LED 102b, so that in case a LED 102b is off the “excess” voltage leads to power being “wasted” across the current source 108b. A possible solution to this issue is the use of a (fast) converter to regulate and reduce the supply voltage VLED depending on how many LEDs 102b should be on. However this approach works properly only in case of a single string 110b, because in case of multiple strings 110b each string 110b may require a different voltage drop at a certain time point.

Aspects of the present disclosure are related to a circuit architecture for driving a LED string or a plurality of LED strings that is adapted to provide a more energy-efficient operation compared to conventional approaches. In particular, the present disclosure may be related to a “multi-level” supply voltage concept, in which a plurality of supply voltages are available for defining the voltage across a LED string. The proposed circuit architecture may implement a dynamic selection of which and how many of the supply voltages to use for defining the voltage across a LED string.

Illustratively, in case only a few LEDs of the string emit light, a corresponding low supply voltage may be delivered to the string by selecting only one of the available supply voltages, or by selecting a combination of supply voltages that deliver a low voltage value. In a corresponding manner, if many or all the LEDs of the string emit light, a corresponding high supply voltage may be delivered to the string, e.g. by selecting a combination of supply voltages that deliver a high voltage value.

The individual selection of the supply voltage for a LED string provides an energy-efficient operation by reducing the power loss at the current source of the LED string. The dynamic adaptation of which and how many supply voltages are delivered to the string allows providing the voltage needed for obtaining light emission from the desired number of LEDs, without power loss caused by “excess voltage” due to the LEDs that do not emit light.

Furthermore, the proposed approach may be conveniently extended to a configuration with a plurality of LED strings, in which the supply voltage for each string may be adapted by suitably selecting and delivering some (or all) of the available supply voltages to the string. In the proposed configuration, the voltage sources that generate the plurality of supply voltages may be common to a plurality of LED strings, and the individual adaptation of the supply voltage for a LED string may be carried out in a space- and resource-efficient manner by a switch circuit. Illustratively, the plurality of supply voltages may define a group of supply voltages available for powering each of the plurality of LED strings, and the specific combination of the available supply voltages that are delivered to a LED string may be individually adapted to the actual power requirements of that LED string at that time point.

According to various aspects, a circuit may include: a plurality of voltage sources, wherein each voltage source of the plurality of voltage sources is configured to generate a respective voltage; a plurality of voltage rails, wherein each voltage rail of the plurality of voltage rails is coupled with a respective voltage source of the plurality of voltage sources; a plurality of strings of light emitting diode, LED, devices, wherein each string of LED devices includes a plurality of LED devices connected in series with one another; a switch circuit configured to selectively couple or decouple each string of LED devices with the voltage rails, wherein, for each string of LED devices, the switch circuit is configured to allow a simultaneous coupling of the string of LED devices with each voltage rail of the plurality of voltage rails; and a control circuit configured to, for each string of LED devices, control the switch circuit to selectively couple the string of LED devices with one or more voltage rails of the plurality of voltage rails.

According to various aspects, a circuit may include: a plurality of voltage rails, wherein each voltage rail of the plurality of voltage rails is configured to be coupled with a respective voltage source of a plurality of voltage sources; a string of light emitting diode (LED) devices connected in series with one another; a switch circuit configured to selectively couple or decouple the string of LED devices with the voltage rails; and a control circuit configured to control the switch circuit to selectively couple the string of LED devices with one or more voltage rails of the plurality of voltage rails.

According to various aspects, a circuit may include: a plurality of voltage sources, wherein each voltage source of the plurality of voltage sources is configured to generate a respective voltage; a plurality of voltage rails, wherein each voltage rail of the plurality of voltage rails is coupled with a respective voltage source of the plurality of voltage sources; a string of light emitting diode (LED) devices connected in series with one another; a switch circuit configured to selectively couple or decouple the string of LED devices with the voltage rails; and a control circuit configured to control the switch circuit to selectively couple the string of LED devices with one or more voltage rails of the plurality of voltage rails.

In an exemplary configuration, the individual selection of the voltage to be defined across a LED string may be dynamically adapted during the duty cycle of a pulse-width modulation (PWM) scheme for the delivery of current to the LEDs. Illustratively, the PWM may define the average current perceived by a LED during a certain time period, e.g. to control the brightness of the emitted light, and the supply voltage delivered to the LED string may be dynamically adapted to follow the duty cycle of the PWM, thus providing an energy efficient light emission. Illustratively, for increasing duty cycle an increasing voltage may be delivered to the LED string, e.g., by coupling the string with more voltage rails or with a combination of voltage rails that delivers a higher voltage.

The proposed approach may be of particular relevance for applications in the automotive context, e.g. a headlight of a vehicle may include one or more circuits configured as proposed herein. For example, a headlight of a vehicle may include a pixelated light fixture including a plurality of LED pixels, and the proposed approach may enable an energy-efficient operation of the headlight even in case the headlight includes a high number of pixels, e.g. more than 1000 pixels, or more than 10000 pixels, or more than 20000 pixels.

Thus, in the present disclosure particular reference may be made to the application of the proposed circuit architecture for automotive applications. It is however understood that the circuit described herein may be also for use in other application scenarios in which a power-efficient driving of LED strings may be beneficial. As other examples, the proposed circuit may be integrated in a display device, such as in a television (e.g., for backlight illumination) or a mobile communication device, in a home appliance, in a light fixture for illuminating a room, etc.

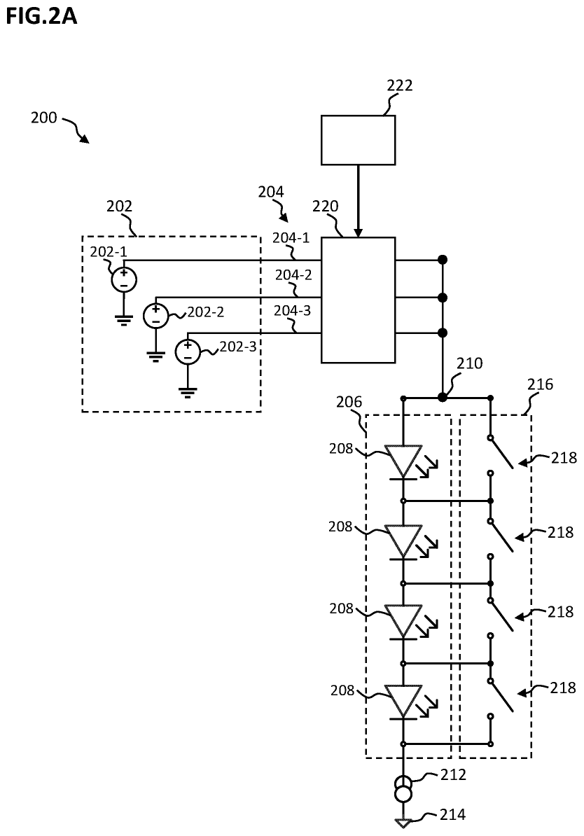

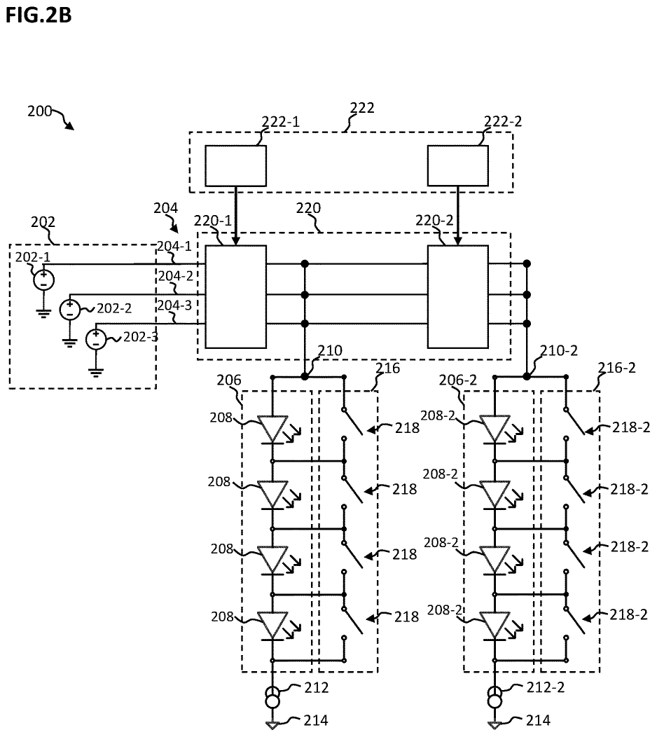

FIG. 2A shows a circuit 200 having an adapted architecture for driving a string of LED devices, in a schematic representation according to various aspects. The circuit 200 may be configured to implement a driving scheme including a multi-level supply voltage for a string of LED devices. As an exemplary application, a vehicle may include one or more circuits 200, e.g. as part of a headlight, or a door, or of an interior illumination system, and the like.

The circuit 200 may include a plurality of voltage sources 202, each configured to provide a respective voltage (illustratively, a respective supply voltage or driving voltage). In the exemplary configuration in FIG. 2A, the circuit 200 may include three voltage sources 202, e.g. a first voltage source 202-1, second voltage source 202-2, and third voltage source 202-3. It is however understood that the circuit 200 may include any suitable number of voltage sources 202, e.g. two, three, four, five, etc., for example depending on the available area and on considerations regarding the maximum current that should be flowing through the circuit 200.

A voltage source 202 may illustratively be understood as a source of supply voltage for the LED devices of the circuit 200. The respective voltage value generated by a voltage source may be selected as any suitable value depending on circuit considerations. In general, considering the driving of a string 206 of LED devices 208, the voltage sources 202 may be configured such that a sum of the individual voltages is at least equal to (or greater than) a sum of the forward voltages of the LED devices 208 of the string 206. As a further example, the minimum voltage generated by the voltage sources 202 may be at least equal to (or greater than) the smallest forward voltage required to enable light emission by one LED device 208 of the string 206.

As an exemplary configuration, the voltage sources 202 may be configured such that each voltage source 202 generates voltage with a unique voltage value among the plurality of voltage sources. For example, the first voltage source 202-1 may generate a first voltage with a first voltage value, the second voltage source 202-2 may generate a second voltage with a second voltage value, the third voltage source 202-3 may generate a third voltage with a third voltage value, etc. For example, the first voltage value may be different from the second voltage value and the third voltage value. Correspondingly, the second voltage value may be different from the first voltage value and the third voltage value, etc.

A configuration with unique voltage values may provide a flexible selection of the voltage to be provided at the string 206 of LED devices 208. For example, the respective voltage generated by a voltage source 202 may correspond to the voltage to be used for obtaining light emission by one or more of the LED devices 208 of the string 206, e.g. the voltage may be equal to or greater than the forward voltage for enabling the light emission by the one or more LED devices.

For example, the first voltage may correspond to a first forward voltage for light emission by a first number of LED devices 208, the second voltage may correspond to a second forward voltage for light emission by a second number of LED devices 208, the third voltage may correspond to a third forward voltage for light emission by a third number of LED devices 208, etc.

In some aspects, the voltage sources 202 may be configured to generate voltages having voltage values that are a multiple of a reference voltage value. Such configuration may enable a straightforward selection of the voltages to be delivered to the string 206 of LED devices 208. For example, the first voltage may be considered as the reference voltage having the reference voltage value. The second voltage may be an integer multiple of the first voltage, for example the second voltage value may be twice the first voltage value. The third voltage may be an integer multiple of the first voltage, for example the third voltage value may be four times the first voltage value, etc. Any suitable relationship may be selected depending on a desired operation of the circuit. The voltage value of the voltage generated by a voltage source 202 may thus be any suitable (integer) multiple of the reference voltage, e.g. the multiplying factor may be one, two, three, four, five, or any suitable factor. In some aspects, the multiplying factor may be a non-integer number, e.g. 1.5 or 2.5 as examples.

In other aspects, some of the voltage sources 202 may generate voltage having the same voltage value. For example, all the voltage sources 202 may generate voltage with the same voltage value, or a subset of the voltage sources 202 may generate voltage with the same voltage value. As an example, each voltage source 202 may generate voltage having a voltage value corresponding to the forward voltage for obtaining light emission by one LED device 208, or by a subset of LED devices 208. In this configuration, the first voltage value may be equal to the second voltage value, and/or the first voltage value may be equal to the third voltage value, etc. This configuration may provide another convenient selection of which voltages to supply to the string 206 of LED devices 208.

The voltage value of the voltages provided by the voltage sources 202 may be in any suitable voltage range adapted depending on circuit considerations, e.g. depending on the type of LED devices 208, on the number of LED devices 208, etc. As a numerical example, the voltage provided by a voltage source 202 may have a voltage value in the range from 3 V to 100 V, for example a voltage value in the range from 5 V to 70 V, for example a voltage value in the range from 10 V to 50 V.

As an exemplary implementation, the plurality of voltage sources 202 may be realized via a DC-DC converter configured to receive a voltage and provide, at its outputs, a plurality of different voltages. Each output of the DC-DC converter may be considered as a voltage source 202 configured to provide a respective voltage. Considering an integration of the circuit 200 in a vehicle, the DC-DC converter may be coupled with a battery unit of the vehicle to receive the battery voltage as input voltage, and provide at its output(s) the different voltages for the operation of the circuit 200. It is however understood that any other suitable implementation may be provided to realize the plurality of voltage sources 202. According to various aspects, the plurality of voltage sources 202 may be or include a single voltage source with a plurality of voltage outputs, each at a respective voltage.

According to various aspects, the circuit 200 may include a plurality of voltage rails 204. Each voltage rail 204 may be configured to be coupled with a respective voltage source 202, in some aspects each voltage rail 204 may be coupled with a respective voltage source 202. In the exemplary configuration in FIG. 2A, the circuit 200 may thus include a first voltage rail 204-1 coupled with the first voltage source 202-1, a second voltage rail 204-2 coupled with the second voltage source 202-2, and a third voltage rail 204-3 coupled with the third voltage source 202-3. It is however understood that the circuit 200 may include any suitable number of voltage rails 204 adapted to the number of voltage sources 202. Only as a numerical example, the number of voltage rails 204 may be in the range from two to ten, for example in the range from two to five.

A voltage rail 204 may illustratively be an electrically conductive path for delivering the voltage from a voltage source 202 to the string 206 of LED devices 208. As an exemplary realization, a voltage rail 204 may include an electrically conductive trace, e.g. a metal trace, providing an electrical connection between the respective voltage source 202 and the string 206 of LED devices 208. By way of illustration, a voltage rail 204 may be a branch at which a respective voltage is present. Stated in a different fashion, each of the plurality of voltage rails 204 may be configured to be at a respective voltage value of supply voltage.

According to various aspects, the circuit 200 may further include a string 206 of light emitting diode (LED) devices 208 (or a plurality of strings, as shown in FIG. 2B). The LED devices 208 of the string 206 may be connected in series with one another. As will be described in further detail below, the LED devices 208 may be connected in series between an input terminal 210 of the string 206 and a current source 212 of the string 206. For example, a first LED device 208 may have its anode connected with the input terminal 210, and its cathode connected with the anode of the next LED device 208 in the string 206. The last LED device 208 may have its anode connected with the cathode of the preceding LED device 208 in the string, and may have its cathode connected with the current source 212.

In principle, the LED devices 208 may be of any suitable type. In general, a LED device 208 may be configured to emit light having a predefined wavelength, for example in the visible range (e.g., from about 380 nm to about 700 nm), infrared and/or near-infrared range (e.g., in the range from about 700 nm to about 5000 nm), or ultraviolet range (e.g., from about 100 nm to about 400 nm). In some aspects, the LED devices 208 may be configured to emit light in different wavelength ranges. For example a first LED device 208 of the string 206 may be configured to emit light in a first wavelength range (e.g., a first color, for example blue), a second LED device 208 of the string 206 may be configured to emit light in a second wavelength range (e.g., a second color, for example red), and a third LED device 208 of the string 206 may be configured to emit light in a third wavelength range (e.g., a third color, for example green), etc. In some aspects, at least one LED device 208 (e.g. a subset of LED devices 208, e.g. each LED device 208) may be configured to emit laser light. In some aspects, at least one LED device 208, e.g. each LED device 208, may be configured as a Micro-LED.

Thus, in some aspects the LED devices 208 may have the same forward voltage (which depends on the type of LED device, illustratively on the type of semiconductor material). In this configuration, the first forward voltage of a first LED device 208 may be equal to a second forward voltage of a second LED device 208, to a third forward voltage of a third LED device 208 etc. In other aspects, the LED devices 208 may have different forward voltages, e.g. the first forward voltage may be different from the second forward voltage, and/or different from the third forward voltage, etc.

In principle, the string 206 may include any suitable number of LED devices 208. As numerical examples, the string 206 may include a number of LED devices 208 in the range from two to twenty, for example in the range from three to fifteen, for example in the range from four to ten. In general, the number of LED devices 208 may be selected depending on the voltage and current available for driving the LED string 206.

According to various aspects, the circuit 200 may further include a current source 212 connected with the string 206 of LED devices 208. Illustratively, the current source 212 may be connected in series to the LED devices 208, and may be configured to generate a current and cause a flow of the generated current through the string 206 of LED devices 208. In a preferred configuration, the current source 212 may be configured to draw current from the supply, thus causing the current to flow from the input terminal 210 through the string 206 of LED devices 208 (towards a reference terminal 214). This configuration may be implemented with components that occupy less area compared to other driving methods. However, also other configurations may be provided, e.g. in other aspects the current source 212 may be configured to supply a current to the string 206 of LED devices 208.

In principle, there may be various configuration possible for the current source 212. As a simple configuration, the current source 212 may include a current mirror, e.g. a cascode current mirror. As a further exemplary configuration, the current source 212 may include an operational amplifier with a feedback loop. The current source 212 may be configured to provide any suitable current value, e.g. depending on the number of LEDs, the type of LEDs, etc. Only as a numerical example, a current generated by the current source 212 may have a current value in the milliampere (mA) range, e.g. from 1 mA to 1000 mA, e.g. from 10 mA to 500 mA, e.g. from 20mA to 100 mA.

The reference terminal 214 may be a terminal at which a reference voltage for the circuit 200 is provided. The term “reference voltage” may be used herein to denote a base voltage for the circuit 200. In some aspects, the reference voltage may be also referred to as ground (GND) voltage, ground potential, virtual ground voltage, or zero volts (0 V). In an exemplary configuration the reference voltage may be 0 V, but the aspects described herein may apply in principle to any suitable value for the reference voltage. The reference terminal 214 may also be referred to as ground terminal. The voltage sources 202 may be coupled to the same reference voltage as the string 206 of LED devices 208.

With a string-like configuration for the LED devices 208, the current source 212 may be common to all the LED devices 208 of the string 206. Illustratively, a single current source 212 may be provided for causing/obtaining a flow of current through all the LED devices 208 of the string 206, thus providing a space- and resource-efficient configuration. In general, various mechanisms may be adopted for controlling the flow of current through the LED devices 208, e.g. for controlling the current value of the current perceived by the LEDs, and correspondingly regulate the brightness of the emitted light. Some possible strategies will be discussed in further detail below.

According to various aspects, the circuit 200 may further include a switch arrangement 216 configured to selectively enable or disable a flow of current through the LED devices 208. For example, the switch arrangement 216 may include a plurality of switchable element 218, each associated with a respective LED device 208. A switchable element 218 may be configured to selectively enable or disable a flow of current through the respective LED device 208. Illustratively, a switchable element 218 may be configured to selectively allow or prevent the flow of current through the respective LED device 208.

As an exemplary realization, as shown in FIG. 2A, the switchable elements 218 may be configured as bypass switches (short switches). In this configuration, a switchable element 218 may be configured to selectively connect an electrically conductive path that bypasses the respective LED device 208. Illustratively, the switchable element 218 may be controlled to close a low resistance path so that current flows through the low resistance path bypassing the respective LED device 208, or may be controlled to open the low resistance path so that the current flows through the respective LED device 208. The low resistance path may be an electrically conductive path with a lower resistance compared to the LED device 208, so that closing the switchable element 218 may short circuit the respective LED device 208.

The configuration with bypass switches allows an energy-efficient operation, by maintaining the current flow through the string 206, i.e. either through the LED devices 208 or through the associated low resistance paths. However, also other configurations may be provided. As another example, a switchable element 218 may be configured to selectively connect or disconnect an electrically conductive path between the current source 212 and the respective LED device 208. Illustratively, the switchable element 218 may be controlled to close the path and allow current to reach (and flow through) the LED device 208, or may be controlled to open the path and prevent current from reaching (and flowing through) the LED device 208.

As an exemplary implementation, a switchable element 218 may include a transistor, e.g. a Metal Oxide Semiconductor (MOS) transistor such as an NMOS or PMOS, a Field Effect Transistor (FET), a MOSFET, a Bipolar Junction Transistor (BJT), and the like. It is however understood that a switchable element 218 may be realized in any suitable manner, e.g. as a single element or as a combination of elements to achieve the switching functionality.

According to various aspects, to implement the multi-level supply voltage scheme, the circuit 200 may include a switch circuit 220 configured to selectively couple or decouple the string 206 of LED devices 208 with the voltage rails 204. The switch circuit 220 may be operable to selectively allow the delivery of voltage from one or more of the voltage sources 202 to the string 206 of LED devices 208. Illustratively, the switch circuit 220 may be configured to selectively enable or disable an electrically conductive coupling of the string 206 (e.g., of the input terminal 210) with one or more of the voltage rails 204 (and accordingly with one or more of the voltage sources). Controlling the switch circuit 220 may thus correspondingly control the voltage at the input terminal 210 of the string 206, and accordingly the voltage drop across the LED devices 208.

The switch circuit 220 may be operable to couple the string 206 of LED devices 208 with one voltage rail 204, or with more than one voltage rail 204 at the same time (e.g., with each voltage rail 204 at the same time). Illustratively, the switch circuit 220 may allow coupling the string 206 of LED devices 208 with one, more than one, or each voltage rail 204 simultaneously, thus enabling the delivery of one voltage or a combination of multiple voltages to the string 206. Stated in a different fashion, the switch circuit 220 may be operable such that the string 206 may receive voltage from one, more than one, or each voltage source 202 at the same time (at the input terminal 210). The switch circuit 220 may thus be configured to allow delivering to the string 206, at a certain time point, voltages from any combination of voltage sources 202 by coupling the string 206 to a corresponding combination of voltage rails 204.

The circuit 200 may further include a control circuit 222 configured to control the switch circuit 220. The control circuit 222 may be configured to operate the switch circuit 220 to cause a coupling or decoupling of the string 206 of LED devices 208 (e.g., of the input terminal 210) with one or more of the voltage rails 204 (and accordingly with one or more of the voltage sources). The control circuit 222 may thus be configured to determine (e.g., identify, select) a voltage to be delivered at the string 206 of LED devices 208 and control the switch circuit 220 accordingly to couple the voltage rails 204 (and voltage sources 202) that in combination provide that voltage to the string 206.

By way of illustration, the control circuit 222 may be aware of a number of LED devices 208 of the string that emit light (or should emit light) at a certain time point, and may control the switch circuit 220 to cause a delivery of a voltage to the string 206 that is sufficient for supporting the light emission by the number of LED devices 208. For example, the control circuit 222 may control the switch circuit 220 based on a known number of LED devices 208 that are (or should be) active at a certain time point to define a supply voltage for the LED devices 208 at that time point that enables light emission from the active LED devices 208.

As an exemplary configuration, considering a number N of LED devices 208 in the string 206, and a number M of LED devices 208 that are active at a certain time point to emit light, the control circuit 222 may control the switch circuit 220 to define a voltage drop across the string 206 that enables light emission by the M LED devices 208. For example, the voltage drop may be greater than the sum of the forward voltages of the M LED devices 208 and less than the sum of the forward voltages of the N LED devices 208 (considering M<N). Stated in a different fashion, the control circuit 222 may control the switch circuit 220 to provide a voltage drop across the string 206 that is a function of the number of LED devices 208 that emit light at that time point.

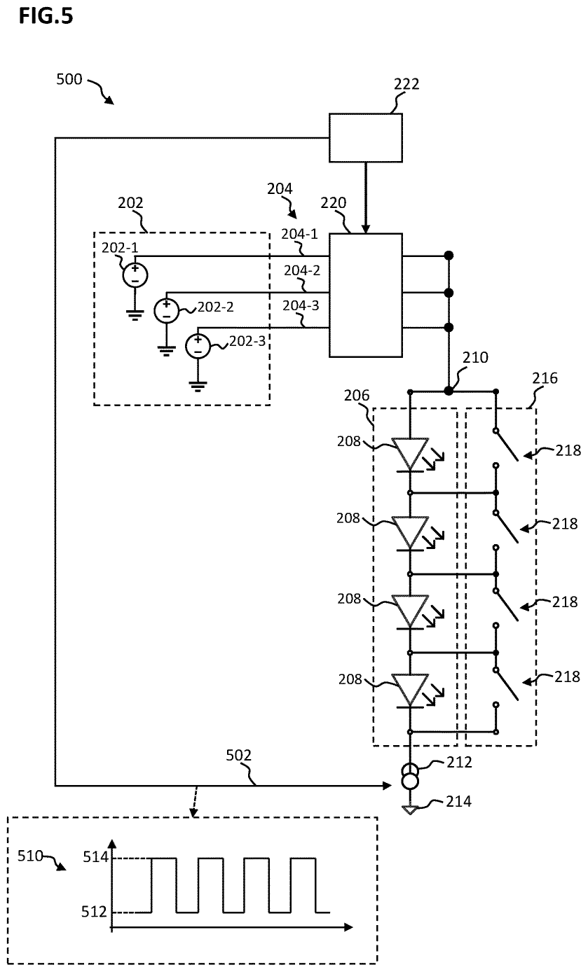

With the proposed “smart” voltage delivery, the power consumption of the circuit 200 may be reduced. Illustratively, considering the power consumption as the voltage multiplied by the current, the reduction of the delivered voltage to what is actually necessary for the light emission ensures that there is no dissipation caused by excess voltage that does not contribute to the light emission itself. The voltage loss over the current source 212 is thus reduced. In some aspects, the control circuit 222 may be configured to control the switch circuit 220 in accordance (e.g., in synchronization) with an operation of the current source 212 and switchable elements 218, as will be described in further detail in relation to FIG. 5.

According to various aspects, the control circuit 222 may be further configured to control the switchable elements 218. For example, the control circuit 222 may include a circuit portion dedicated to controlling the switch circuit 220 and a circuit portion dedicated to controlling the switchable elements 218. In another configuration, a further circuit may be configured to control the switchable elements 218, and the control circuit 222 and the further circuit may be communicatively coupled with one another.

In an exemplary configuration, the control circuit 222 may be configured to control the switch circuit 220 in accordance (e.g., in synchronization) with the control of the switchable elements 218, e.g. with the control of the plurality of bypass switches. The control circuit 222 may be configured to operate the switch circuit 220 to enable the coupling of the string 206 with one or more of the voltage rails 204 depending on the number of switchable elements 218 that enable current flow through the respective LED device 208 (at that time point).

Illustratively, the control circuit 222 may be configured to operate the switch circuit 220 based on a (known) number of switchable elements 218 that are in a state that allows current to flow through the respective LED device 208. For example, considering bypass switches, the control circuit 222 may be configured to operate the switch circuit 220 based on a (know) number of bypass switches that are open so that current flows through the respective LED element 208.

For example, the control circuit 222 may be configured to operate the switch circuit 220 to selectively couple the string 206 of LED devices 208 to a number of voltage rails that depends on the number of switchable elements 218 that are switched to allow a current flow through the respective LED device 208. For example, there may be a direct dependency, so that for an increasing number of “active” switchable elements 218 that enable current flow through the corresponding LED device 208 the control circuit 222 may operate the switch circuit 220 to couple an increasing number of voltage rails 204 with the string (and accordingly fewer voltage rails for fewer “active” switchable elements 218).

As another example, the control circuit 222 may be configured to operate the switch circuit 220 to selectively couple the string 206 of LED devices 208 to voltage rails 204 that (in combination) deliver a certain voltage to the string 206, based on the number of activated switchable elements 218. For example, there may be a direct dependency, so that for an increasing number of “activated” switchable elements 218 the control circuit 222 may operate the switch circuit 220 to couple voltage rails 204 that in combination deliver an increasing voltage at the string 206 of LED devices 208 (and accordingly a decreasing voltage for fewer “activated” switchable elements 218).

As mentioned, the proposed approach may be extended to a scenario with a plurality of strings of LED devices. In this regard, FIG. 2B shows a configuration in which the circuit 200 includes a plurality of strings 206, 206-2 of LED devices 208, 208-2. In the exemplary configuration in FIG. 2B, two strings 206, 206-2 are illustrated, but it is understood that the circuit 200 may include any suitable number of LED strings, e.g. two, three, four, five, ten, one hundred, one thousand, etc. Each string 206, 206-2 may include respective LED devices 208, 208-2, input terminal 210, 210-2, current source 212, 212-2, and switch arrangement 216, 216-2 with the switchable elements 218, 218-2.

Different strings 206, 206-2 of LED devices 208, 208-2 may be configured in the same manner or in a different manner. For example, different strings 206, 206-2 may include the same number of LED devices 208, 208-2. Illustratively, a first string 206 may include a first number of LED devices 208, a second string 206-2 may include a second number of LED devices 208-2, and the first number may be equal to the second number. A third string may include a third number of LED devices, and the first number may be equal to the third number, etc.

In other aspects, different strings 206, 206-2 may include a different number of LED devices 208, 208-2. Illustratively, the first number of LED devices 208 may be different from the second number of LED devices 208-2. The first number and/or the second number may be different from the third number of LED devices, etc.

As another example, different strings 206, 206-2 may include LED devices 208, 208-2 of the same type, e.g. LED devices 208, 208-2 configured to emit the same color. For example, the (first) LED devices 208 of the first string 206 may be configured to emit light having a certain color (a certain wavelength), and the (second) LED devices 208-2 of the second string 206-2 may be configured to emit light having that color (that wavelength). Further, (third) LED devices of a third string may be configured to emit light having that color, etc.

In other aspects, different strings 206, 206-2 may include LED devices 208, 208-2 of different types, e.g. LED devices 208, 208-2 configured to emit different colors. For example, the (first) LED devices 208 of the first string 206 may be configured to emit light having a certain color (a certain wavelength), and the (second) LED devices 208-2 of the second string 206-2 may be configured to emit light having a different color (a different wavelength). Further, (third) LED devices of a third string may be configured to emit light having a further different color, etc.

In general, the strings 206, 206-2 of LED devices 208, 208-2 may be coupled in parallel with one another, and may be coupled with the voltage rails 204 over the switch circuit 220. In a preferred configuration, each string 206, 206-2 may be selectively connectable to all the voltage rails 204. Illustratively, all the voltage rails 204 (and voltage sources 202) are available for each string 206, 206-2. The voltage rails 204 may thus define a pool (a group) of voltage rails common to all the strings 206, 206-2 and may be selectively connected/disconnected to each string 206, 206-2. In another configuration, different strings 206, 206-2 may be selectively connectable to a different number of voltage rails 204. For example, a first string 206 may be connectable to all the voltage rails 204, and another string 206-2 may be connectable to a subset of the voltage rails 204. This configuration may be provided, for example, in case different strings 206, 206-2 include a different number of LED devices 208, 208-2.

In a configuration with a plurality of strings 206, 206-2 of LED devices 208, 208-2, the switch circuit 220 may be configured to selectively couple or decouple each string 206, 206-2 of LED devices 208, 208-2 with the voltage rails 204. Illustratively, the switch circuit 220 may be operable to couple each string 206, 206-2 with one or more of the voltage rails 204 depending on the voltage to be provided at that string 206, 206-2 (e.g., at the respective input terminal 210, 210-2). As an exemplary configuration, as shown in FIG. 2B, the switch circuit 220 may include a plurality of switch (sub-)circuits 220-1, 220-2, each associated with a respective string 206, 206-2, and configured to selectively couple or decouple the respective string 206, 206-2 with the voltage rails 204.

The switch circuit 220 may be operable to couple each string 206, 206-2 of LED devices 208-2 with one voltage rail 204, or with more than one voltage rail 204 at the same time (e.g., with each voltage rail 204 at the same time). Illustratively, the switch circuit 220 may allow coupling each string 206, 206-2 of LED devices 208, 208-2 with one, more than one, or each voltage rail 204 simultaneously, thus enabling a respective delivery of one voltage or a combination of multiple voltages to each string 206, 206-2 (tailored to the specific voltage needs of that string 206, 206-2).

In a configuration with a plurality of strings 206, 206-2 of LED devices 208, 208-2, the control circuit 222 may be configured to control the switch circuit 220 to selectively couple each string 206, 206-2 of LED devices 208, 208-2 with one or more of the voltage rails 204. Illustratively, the control circuit 222 may be configured to operate the switch circuit 220 (e.g., the individual sub-circuits 220-1, 220-2) to couple each string 206, 206-2 with a certain number of voltage rails 204 to define a certain voltage drop across that string 206, 206-2.

As an exemplary configuration, as shown in FIG. 2B, the control circuit 222 may include a plurality of control (sub-)circuits 222-1, 222-2, each associated with a respective string 206, 206-2 and configured to operate the switch circuit 220 to control the voltage delivery at the respective string 206, 206-2. For example, each control (sub-)circuit 222-1, 222-2 may be configured to control a respective switch (sub-)circuit 220-1, 220-2. By way of illustration, in this scenario a dedicated controller may select per column (string) the optimal supply voltage depending on the number of LEDs which are active (e.g., not shorted) in this column, by operating the related switch circuit.

The proposed approach may thus enable an individual tailoring of the voltage drop across the different strings 206, 206-2, depending on the actual voltage requirements for that string 206, 206-2 at a certain time point. The control circuit 222 (e.g., the individual sub-circuits 222-1, 222-2) may thus be configured to control the switch circuit 220 to selectively couple, at the same time point, a (first) string 206 with a first number of voltage rails 204, a second string 206-2 with a second number of voltage rails 204, a third string with a third number of voltage rails 204, etc.

The control circuit 222 may select, for each string 206, 206-2, which voltage rails 204 should be coupled with the respective input terminal 210, 210-2 at a certain time point. In this regard, the first number of voltage rails 204 coupled with the (first) string 206 may be equal to or different from the second number of voltage rails 204 coupled with the second string 206-2. The first number and/or the second number of voltage rails 204 may be equal to or different from the third number of voltage rails 204 coupled with the third string, etc.

Additionally or alternatively, the number of coupled voltage rails 204 may be equal, but what may differ is the respective voltage delivered to the each string 206, 206-2. For example, the first number of voltage rails 204 coupled with the (first) string 206 may be deliver a first combined voltage different from a second combined voltage delivered by a second number of voltage rails 204 coupled with the second string 206-2. The first combined voltage and/or the second combined voltage may be equal to or different from a third combined voltage delivered by a third number of voltage rails coupled with a third string, etc.

With the proposed approach, each string 206, 206-2 of LED devices 208, 208-2 may thus be switched to a (different) VLED that provides the optimum power consumption for that string 206, 206-2.

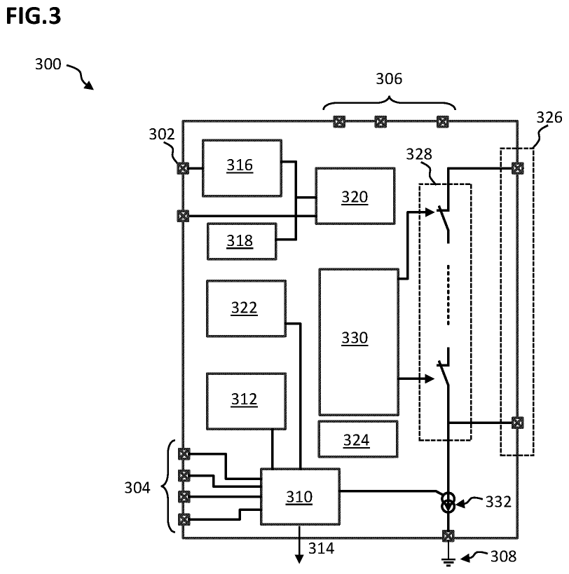

According to various aspects, one or more components of the circuit 200 may be integrated together, e.g. may be part of an integrated circuit (IC). As an example, the LED devices 208 of a string 206 may be monolithically integrated in an integrated circuit (while leaving accessible at least one anode and one cathode for coupling with the supply and the current source). For example, a string 206 may be configured according to monolithic LED technology including a common anode and a common cathode, with the LEDs being integrated on a common substrate (vertical technology). As another example, the control circuit 222 may be part of an integrated circuit with one or more additional components (see FIG. 3). For example, the control circuit 222 and the switchable elements 218 controlling the LEDs may be part of the same integrated circuit.

It is understood that the representation of the circuit 200 in FIG. 2A and FIG. 2B may be simplified, and the circuit 200 may include additional elements with respect to those shown. In this regard, FIG. 3 shows an exemplary configuration of a driver circuit 300 for driving a string of LED devices. The driver circuit 300 may be configured to implement some of the functionalities discussed in relation to FIG. 2A and FIG. 2B, and may illustrate possible exemplary components to implement further functionalities. It is understood that the configuration of the driver circuit 300 is exemplary, and the driver circuit 300 may include additional, less, or alternative components with respect to those shown.

In general, the driver circuit 300 may include a supply terminal 302 to receive a supply voltage as input voltage for powering an operation of the driver circuit 300. In addition to the input terminal 302, the driver circuit 300 may include various further terminal for coupling with external circuit and components. For example, the driver circuit 300 may include one or more data terminals 304 for data transmission and reception. The data terminals 340 may include, for example, a chip select terminal, CS, to receive a chip select signal; a clock terminal, SCLK, to receive a clock signal, a multiple input single output, MISO, to receive data, and a multiple output single input, MOSI, to output data. As another example, the driver circuit 300 may include one or more test terminals 306 at which test signals may be provided to carry out a testing of the driver circuit 300, e.g. a testing of one or more components of the driver circuit 306. The driver circuit 300 may be coupled with a reference terminal 308.

The driver circuit 306 may further include a digital processing circuit 310 (a digital core) coupled with the data terminals 304 and configured to carry out digital processing. For example, the digital processing circuit 310 may be coupled with a memory 312 configured to store instructions for the digital processing circuit 310. For example, the memory 312 may store data and parameters for an operation of the driving circuit 300. As an exemplary implementation, the memory 312 may be a one-time programmable (OTP) memory. For example, the digital processing circuit 310 may be configured to carry out the functionality of the control circuit 222 described in relation to FIG. 2A and FIG. 2B, e.g. may be configured to generate a control signal 314 for controlling a switch circuit to regulate the voltage delivery at a string of LED devices.

The driver circuit 300 may further include a reversal protection circuit 316 configured to protect the driver circuit 300 from reverse input voltage. Illustratively, the reversal protection circuit 316 may be configured to block a negative portion of the input voltage at the input terminal 302. The driver circuit 300 may further include an overvoltage detection circuit 318 configured to monitor the input voltage (e.g., as output by the reversal protection circuit 316) and trigger a shutdown of the driver circuit 300 in case of overvoltage.

The driver circuit 300 may further include a power management circuit 320 coupled with the reversal protection circuit 316 and the overvoltage detection circuit 318 and configured to control their operation, e.g. to adjust one or more operating parameters of such circuits. For example, the power management circuit 320 may be an internal low-dropout regulator to generate a fixed voltage independently of the input voltage, thus providing a controlled voltage value for powering the components that require a small supply voltage, or in general a smaller supply voltage than other components of the driver circuit 300.

Regarding temperature protection, the driver circuit 300 may include a temperature sensor 322 and a thermal shutdown circuit 324. The temperature sensor 322 may be configured to sense a temperature of the driver circuit 300, and the thermal shutdown circuit 324 may be a hardwired circuit configured to force a shutdown of the driver circuit 300 if the sensed temperature indicates an over-temperature condition, e.g. if the sensed temperature is greater than a threshold temperature.

The driver circuit 300 may further include a plurality of control terminals 326 configured to be coupled with elements to be driven by the driver circuit 300. For example, the plurality of control terminals 326 may be coupled with the LED devices of a string of LEDs. The driver circuit 300 may further include a LED control circuit 330 configured to control a behavior of the LED devices coupled with the control terminals 326. For example, the LED control circuit 330 may be configured to control a plurality of switchable elements 328 (e.g., a plurality of transistors) to selectively enable a current flow through a LED device (e.g., of current drawn by a current source 332) or disable the current flow through a LED device, e.g. by bypassing the LED device. The LED control circuit 330 and the digital processing circuit 310 are shown as separate elements. In some aspects, the driver circuit 300 may include a single component implementing the functionalities of the LED control circuit 330 and digital processing circuit 310. For example, the control circuit 222 in FIGS. 2A and 2B may implement the functionalities of the LED control circuit 330.

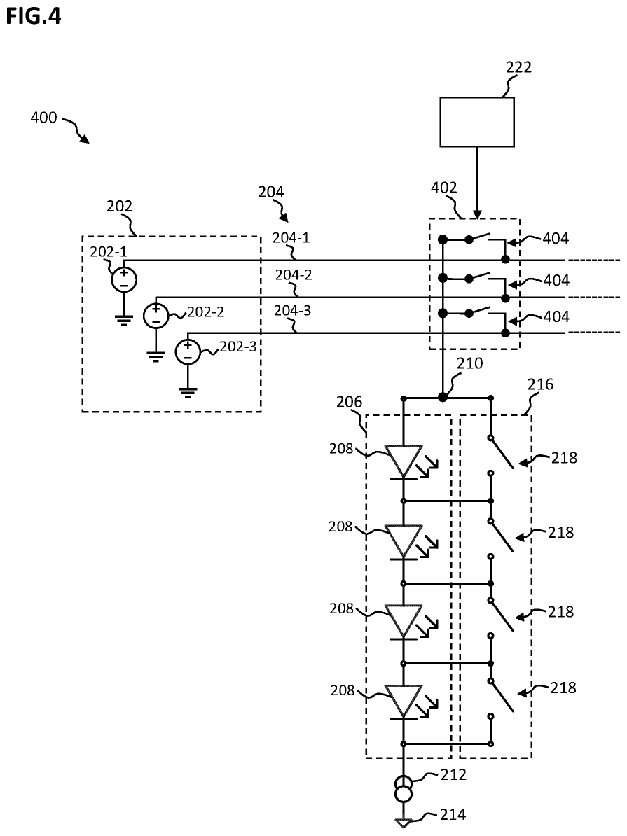

In principle, the switch circuit 220 may be realized in any suitable manner to provide a controlled coupling/decoupling of a string of LEDs with the voltage rails (and voltage sources). In this regard, FIG. 4 shows a circuit 400 with a switch circuit 402, illustratively an exemplary realization of the switch circuit 220 (e.g., of a switch sub-circuit 220-1, 220-2). For the purpose of illustration the circuit 400 in FIG. 4 is shown to include one string of LED devices, but it is understood that the aspects discussed in relation to FIG. 4 may extend in a corresponding manner to a scenario with a plurality of strings of LEDs.

It is also understood that the configuration in FIG. 4 provides a convenient implementation of the proposed approach, but in principle other configurations for the switch circuit 402 may be provided, e.g. including alternative elements to implement the switching functionality described herein. As another exemplary possibility, the switch circuit may include controllable inductive couplers for selectively coupling/decoupling the voltage rails with the string of LED devices.

According to various aspects, the switch circuit 402 may include a plurality of switchable elements 404. Each switchable element 404 may be associated with a corresponding voltage rail 204, and may be configured to selectively couple or decouple the respective voltage rail 204 with the string 206 of LED devices 208. As shown, each switchable element 404 may be operable to connect (close) or disconnect (open) an electrically conductive path between the respective voltage rail 204 and the string 206 of LED devices 208 (e.g., the input terminal 210 thereof). The control circuit 222 may thus be configured to send a control signal to the switch circuit 402, e.g. a plurality of control signals to the plurality of switchable elements 404 to control their behavior. The control circuit 222 may thus be configured to individually control the switchable elements 404 to define the desired voltage drop across the LED devices 208.

As an exemplary implementation, a switchable element 404 may include a transistor, e.g. a Metal Oxide Semiconductor (MOS) transistor such as an NMOS or PMOS, a Field Effect Transistor (FET), a MOSFET, a Bipolar Junction Transistor (BJT), and the like. In this scenario, the control signal from the control circuit 222 to a switchable element 404 may be a signal delivered to a control terminal (e.g., the gate) of the transistor to control a behavior of the channel between the other two terminals (e.g., drain and source) of the transistor.

As mentioned, the control of the switching circuit may be carried out in accordance with the amount of current being delivered to the string of LED devices, e.g. the amount of current being drawn by the current source 212. In this regard, FIG. 5 shows a circuit 500 in which a coordinated control of the switch circuit 220 and current source 212 is implemented. For the purpose of illustration the circuit 500 in FIG. 5 is shown to include one string of LED devices, but it is understood that the aspects discussed in relation to FIG. 5 may extend in a corresponding manner to a scenario with a plurality of strings of LEDs. The aspects discussed in relation to FIG. 5 may be provided in combination or in alternative to the aspects discussed in FIG. 4, e.g. in combination with the configuration of the switch circuit provided in FIG. 4.

According to various aspects, the control circuit 222 may be further configured to control the current source 212 (e.g., the respective current source 212, 212-2 in case of a plurality of strings 206, 206-2), e.g. to control a current value of the current delivered to the LED devices 208. The control circuit 222 may illustratively be configured to send a control signal 502 to the current source 212 to control the current generation by the current source 212 (e.g., to control the amount of current drawn by the current source 212). For example, the control circuit 222 may include a circuit portion dedicated to controlling the switch circuit 220 and a circuit portion dedicated to controlling the current source 212. In another configuration, a further circuit may be configured to control the current source 212, and the control circuit 222 and the further circuit may be communicatively coupled with one another.

In principle, the control circuit 222 may be configured to control the current source 212 according to any suitable driving scheme. In general, a commonly used driving scheme for controlling the delivery of current to a LED or a series of LEDs is the so-called pulse width modulation (PWM). The PWM technique is based on pulsing the power supply on and off at a certain frequency and with a certain pulse width, thus allowing to control the amount of current delivered to the LED(s) over a certain period of time, illustratively the average current perceived by the LED(s) over such period of time. In general, the PWM driving scheme is well known in the art. Some basic concepts are described herein to introduce aspects relevant for the present disclosure.

As an abridged overview, PWM may describe the use of a digital signal to obtain an analog result. A “PWM signal”, e.g. for controlling a current source, may be a square wave switched between a high state (illustratively, an “on state”) and a low state (“off state”). The percentage of time in which the PWM signal is in the high state is the so-called duty cycle. By way of illustration, a PWM signal always on would have a 100% duty cycle, a PWM signal always off would have a 0% duty cycle, a PWM signal on for half of a period would have a 50% duty cycle, and so on. In addition to the duty cycle, another important parameter of a PWM signal is the frequency of the waveform, i.e. the inverse of the period, i.e. the inverse of the complete on-time and off-time of the PWM signal. By controlling the duty cycle of the PWM signal it is possible to control the electrical power perceived by a load.

A relevant use case for the PWM technique is the control of the brightness of light emitted by a LED, the so-called “dimming”. With PWM, a LED is turned on and off with a duty cycle and frequency defined by the PWM signal. By varying the on-time, the brightness of the emitted light as perceived by the human eye may be varied accordingly. The frequency of the PWM signal should be sufficiently high to avoid flickering, i.e. the on/off frequency should be faster than the perception of the human eye (the so-called Flicker Fusion Rate). For LED dimming, the frequency of a PWM signal may be for example around 100 Hz.

According to various aspects, the control signal 502 generated by the control circuit 222 to control the current source 212 (e.g., each current source 212-2) may be a PWM signal. In this regard, FIG. 5 shows an exemplary PWM signal 510 as an exemplary realization of the control signal 502. In general, the PWM signal 510 may vary between a low state 512 and a high state 514 and may have a certain duty cycle and frequency. The duty cycle of the PWM signal 510 may define the amount of current perceived by a LED device 208 over a certain time period.

The duty cycle and frequency of the PWM signal 510 may be selected to have any suitable value depending on the desired operation of the LED devices 208 (e.g., of each string 206, 206-2). As a numerical example, the PWM signal 510 may have a frequency in the range from 60 Hz to 200 Hz, for example a frequency in the range from 70 Hz to 150 Hz, for example a frequency in the range from 80 Hz to 100 Hz. The duty cycle may be selected to provide a certain brightness for the light emitted by the LED devices 208, illustratively the LED devices 208 that are activated by the corresponding switchable element 218. Illustratively, a LED has an amount of power for which the LED produces a maximum output (e.g., light at maximum brightness). The PWM technique is based on switching the LED on and off at high frequency so that the power perceived by the LED varies in a range between 0 and the amount of power corresponding to the maximum output, thus regulating the brightness as a function of the ratio of the on-time to off-time. The duty cycle of the PWM signal 510 may thus assume any value between 0% and 100% depending on the desired brightness for the emitted light.

The control circuit 222 may be configured to control the current source 212 using the PWM signal 510, and may be configured to control the switch circuit 220 in accordance (e.g., in synchronization) with the PWM signal 510. For example, the control circuit 222 may be configured to control the switch circuit 220 as a function of the duty cycle of the PWM signal 510. As an example, for increasing duty cycle the control circuit 222 may operate the switch circuit 220 to couple an increasing number of voltage rails 204 with the string 206 of LED devices 208 (and accordingly fewer voltage rails 204 for decreasing duty cycle). Stated differently, for increasing duty cycle the control circuit 222 may operate the switch circuit 220 to couple voltage rails 204 that in combination deliver an increasing voltage to the string 206 of LED devices 208 (and accordingly a decreasing voltage for decreasing duty cycle).

In case of a plurality of strings 206, 206-2, the control circuit 222 may be configured to control the respective current source 212, 212-2 of each string using a respective PWM signal 510, and may be configured to control the switch circuit 220 in accordance (e.g., in synchronization) with the PWM signal 510 for each string 206, 206-2. Illustratively, for each string 206, 206-2 the control circuit 222 may control the switch circuit 220 to selectively couple the string 206, 206-2 with one or more of the voltage rails 204 as a function of the duty cycle defined by the PWM signal 510 for that string 206, 206-2.

This mechanism may also vary dynamically over time. For example, the duty cycle of the PWM signal 510 may vary over time, such that the PWM signal 510 has different duty cycles in different time periods. For example, the PWM signal 510 may have a first duty cycle in a first time period, a second duty cycle in a second time period a third duty cycle in a third time period, etc. The control circuit 222 may adapt the control of the switch circuit 220 in each time period according to the corresponding duty cycle.

For example, in the first time period the control circuit 222 may operate the switch circuit 220 to couple the string 206 of LED devices 208 to a first number of voltage rails 204, or to voltage rails 204 that in combination deliver a first voltage value. In the second time period the control circuit 222 may operate the switch circuit 220 to couple the string 206 of LED devices 208 to a second number of voltage rails 204, or to voltage rails 204 that in combination deliver a second voltage value. If the first duty cycle is different from the second duty cycle, then the first number of voltage rails 204 may be different from the second number of voltage rails 204, and/or the first voltage value may be different from the second voltage value. In case the first duty cycle is greater than the second duty cycle, the first number of voltage rails 204 may be greater than the second number of voltage rails 204, and/or the first voltage value may be greater than the second voltage value. The same may apply for a third number of voltage rails 204 and/or a third voltage value, etc.

Another approach to LED dimming is the so-called constant current reduction (CCR), in which the LED is maintained constantly on, and the current level of the current delivered to the LED is adjusted in an analog manner to change the brightness of the emitted light. The CCR technique provides thus an “analog dimming”, in which the amplitude of the current is increased or decreased to cause a corresponding increase or decrease in the LED's brightness. In various aspects, the control circuit 222 may be configured to control the current source 212 according to the CCR approach, e.g. may be configured to cause an analog variation of the current value of the generated current. In a corresponding manner as for the PWM-scenario, the control circuit 222 may be configured to operate the switch circuit 220 as a function of the analog value of the generated current. For example, for increasing analog values of the generated current the control circuit 222 may operate the switch circuit 220 to couple an increasing number of voltage rails 204 with the string 206 of LED devices 208 (and accordingly fewer voltage rails for decreasing analog value of the current). As another example for increasing analog values of the generated current the control circuit 222 may operate the switch circuit 220 to couple voltage rails 204 that deliver an increasing voltage to the string 206 of LED devices 208 (and accordingly a decreasing voltage for decreasing analog value of the current).

The aspects discussed in relation to PWM or CCR may apply in a corresponding manner to a combination of the two approaches, the so-called “hybrid PWM”. The proposed scheme ensures a reduced power consumption by optimizing the delivery of voltage to the actual needs of the string(s) of LEDs at a certain time point.

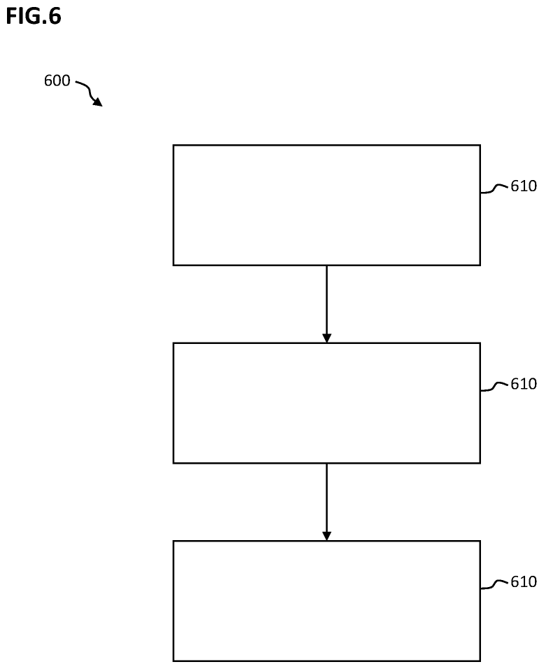

FIG. 6 shows a schematic flow diagram of a method 600 of driving a string of LED devices, e.g. a method of driving a plurality of strings of LED devices, according to various aspects. It is understood that the aspects discussed in relation to the circuit 200, 400, 500 apply in a corresponding manner to the method 600, and vice versa. Illustratively, a functionality carried out by a component of the circuit 200, 400, 500 may correspond to a respective step of the method 600, and a step of the method 600 may correspond to a respective configuration of a component of the circuit 200, 400, 500 to carry out a functionality resulting in the method step.

According to various aspects, the method 600 may include, in 610, generating a plurality of supply voltages. For example, the method 600 may include using a plurality of voltage sources to generate the plurality of supply voltages. In some aspects, the method 600 may include providing each supply voltage at a respective voltage rail of a plurality of voltage rails.

The method 600 may further include, in 620, selectively enabling a delivery of one or more of the generated supply voltages to a string of LED devices to define a voltage drop across the string of LED devices as a sum of the delivered supply voltages. For example, the method 600 may include selectively coupling the string of LED devices with one or more of the voltage rails to deliver one or more of the generated supply voltages to the string of LED devices.

As an exemplary configuration, the method 600 may include controlling a switch circuit (e.g., a plurality of switchable elements) to selectively couple the string of LED devices with one or more of the voltage rails and/or to decouple the string of LED devices from one or more of the voltage rails.

The method 600 may be extended to a scenario with a plurality of strings of LED devices. In this configuration, the plurality of supply voltages may be common to the plurality of strings of LED devices, e.g. the plurality of supply voltages may define a group of supply voltages available for being delivered to the strings of the plurality of strings of LED devices. In this case, the method 600 may include, for each string of LED devices, selectively enabling a delivery of one or more of the generated supply voltages to that string of LED devices to define a respective voltage drop across the string. For example, the method 600 may include selectively enabling a delivery of one or more of the generated supply voltages to a first string of LED devices define a first voltage drop across the first string of LED devices. The method 600 may further include selectively enabling a delivery of one or more of the generated supply voltages to a second string of LED devices define a second voltage drop across the second string of LED devices, etc.

As discussed in relation to the circuit 200, 400, 500, the method 600 may include controlling the delivery of supply voltage to a string of LEDs as a function of a number of LEDs in the string that emit light. For example, the method 600 may include controlling the delivery of supply voltage to a string of LEDs as a function of a current flow through the string of LEDs, e.g. as a function of a number of switchable elements that are activated to allow a current flow through a respective LED device.

In some aspects, the method 600 may include controlling the delivery of supply voltage to a string of LEDs in accordance with a control of a current source that delivers current to the string. For example, the method 600 may include controlling the delivery of supply voltage to a string of LEDs as a function of a duty cycle of a PWM signal used for controlling the delivery of current to the string of LEDs.

The following examples pertain to aspects of the present disclosure, e.g., in relation to the circuit 200, 400, 500, and to the method 600.
Example is a circuit including: a plurality of voltage sources, wherein each voltage source of the plurality of voltage sources is configured to generate a respective voltage; a plurality of voltage rails, wherein each voltage rail of the plurality of voltage rails is coupled with a respective voltage source of the plurality of voltage sources; a string of light emitting diode, LED, devices connected in series with one another; a switch circuit configured to selectively couple or decouple the string of LED devices with the voltage rails; and a control circuit configured to control the switch circuit to selectively couple the string of LED devices with one or more voltage rails of the plurality of voltage rails.
In Example 2, the circuit according to example 1 may optionally further include a current source connected in series to the LED devices and configured to generate a current and cause a flow of the generated current through the string of LED devices, wherein the current source is a common current source for all the LED devices of the string of LED devices.
In Example 3, the circuit according to example 2 may optionally further include a plurality of switchable elements, wherein each switchable element is associated with a respective LED device and is configured to selectively enable or disable a flow of current through the respective LED device, and wherein the control circuit is configured to control the switch circuit as a function of a number of switchable elements that enable the flow of current through the respective LED device.
In Example 4, the circuit according to example 3 may optionally further include that the control circuit is configured to control the switch circuit to selectively couple the string of LED devices to one or more of the voltage rails to deliver an increasing voltage at the string of LED devices for an increasing number of switchable elements that enable the flow of current through the respective LED device.
In Example 5, the circuit according to any one of examples 2 to 4 may optionally further include that the control circuit is further configured to: generate a pulse width modulation, PWM, signal to control a delivery of current from the current source to the string of LED devices; control the current source using the generated PWM signal; and control the switch circuit as a function of the generated PWM signal.
In Example 6, the circuit according to example 5 may optionally further include that the control circuit is configured to control the switch circuit to selectively couple the string of LED devices to one or more of the voltage rails to deliver an increasing voltage at the string of LED devices for an increasing duty cycle of the generated PWM signal.
In Example 7, the circuit according to any one of examples 1 to 6 may optionally further include that the plurality of voltage sources comprise at least a first voltage source configured to generate a first voltage and a second voltage source configured to generate a second voltage, wherein the first voltage is different from the second voltage.
In Example 8, the circuit according to any one of examples 1 to 7 may optionally further include that the circuit comprises a plurality of strings of LED devices comprising the string of LED devices and one or more further strings of LED devices; wherein the switch circuit is configured to selectively couple or decouple each string of LED devices with the voltage rails; and wherein the control circuit is configured to control the switch circuit to selectively couple each string of LED devices with one or more voltage rails of the plurality of voltage rails.
In Example 9, the circuit according to example 8 may optionally further include that the control circuit comprises a plurality of control circuits, each associated with a respective string of LED devices and configured to control the switch circuit to selectively couple the respective string of LED devices with one or more voltage rails of the plurality of voltage rails.
In Example 10, the circuit according to example 8 or 9 may optionally further include that the plurality of strings of LED devices includes at least a first string of LED devices and a second string of LED devices, and that the control circuit is configured to control the switch circuit to couple, at a same time point, the first string of LED devices with one or more voltage rails that deliver a voltage with a first voltage value, and the second string of LED devices with one or more voltage rails that deliver a voltage with a second voltage value, wherein the first voltage value is different from the second voltage value.
In Example 11, the circuit according to any one of examples 1 to 10 may optionally further include that the switch circuit includes a plurality of switchable elements, wherein each switchable element is associated with a corresponding voltage rail, and is configured to selectively connect or disconnect an electrically conductive path between the respective voltage rail and the string of LED devices.
Example 12 is a circuit including: a plurality of voltage rails, wherein each voltage rail of the plurality of voltage rails is configured to be coupled with a respective voltage source of a plurality of voltage sources; a string of light emitting diode, LED, devices connected in series with one another; a switch circuit configured to selectively couple or decouple the string of LED devices with the voltage rails; and a control circuit configured to control the switch circuit to selectively couple the string of LED devices with one or more voltage rails of the plurality of voltage rails.
In Example 13, the circuit according to example 12 may include one or more features of examples 1 to 11, adapted accordingly.
Example 14 is a method of driving a string of LED devices, the method including: generating a plurality of supply voltages, wherein the plurality of supply voltages are common to a plurality of string of LED devices; and for each string of LED devices of the plurality of strings of LED devices, selectively enabling a delivery of one or more of the generated supply voltages to that string of LED devices to define a respective voltage drop across the string of LED devices.
In Example 15, the method of example 14 may optionally further include that generating the plurality of supply voltages comprises providing each of the generated supply voltages at a respective voltage rail of a plurality of voltage rails; and that selectively enabling the delivery of one or more of the generated supply voltages to a string of LED devices comprises selectively coupling the string of LED devices with one or more voltage rails of the plurality of voltage rails.
In Example 16, the method of example 14 or 15 may optionally further include that selectively enabling the delivery of one or more of the generated supply voltages to a string of LED devices comprises selectively enabling the delivery of one or more of the generated supply voltages as a function of a current flow through the string of LEDs; and/or that selectively enabling the delivery of one or more of the generated supply voltages to a string of LED devices comprises selectively enabling the delivery of one or more of the generated supply voltages at a certain time point as a function of a number of LED devices that emit light at that time point.
In Example 17, the circuit according to any one of examples 14 to 16 may include one or more features of examples 1 to 11, adapted accordingly.

The terms “processor”, “processing circuit”, or “control circuit” as used herein may be understood as any kind of technological entity that allows handling of data. The data may be handled according to one or more specific functions that the processor/processing circuit/control circuit may execute. Further, a processor/processing circuit/control circuit as used herein may be understood as any kind of circuit, e.g., any kind of analog or digital circuit. A processor/processing circuit/control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processors/processing circuits/control circuits detailed herein may be realized as a single entity with equivalent functionality or the like, and conversely that any single processor/processing circuit/control circuit detailed herein may be realized as two (or more) separate entities with equivalent functionality or the like.

The term “connected” may be used herein with respect to terminals, integrated circuit elements, devices, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, devices, regions, contacts, etc., may be understood as an electrically conductive connection with, for example, ohmic behavior, e.g. provided by a metal or degenerate semiconductor in absence of p-n junctions in the current path. The term “electrically conductively connected” may be also referred to as “galvanically connected”. The term “coupled” may be used herein in the same manner as the term “connected”.

The term “terminal” may be used herein to describe a location (e.g., a point) or structure of a device or of an element of the device at which a signal (e.g., an analog signal, for example a current or a voltage) may be provided and/or to which another device or element may be connected. Illustratively, a terminal may be a location or a structure that is electrically conductively connected with the device or the element. A terminal may also be referred to herein as port, pin, contact, or contact point.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [. . . ] , etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

Unless specified otherwise, the term “subset” in relation to a group of elements may be understood to include a numerical quantity equal to or greater than one and less than a total number of the implied elements. Considering for example a group of ten elements, a “subset” of the group may include one, two, three, four, five, six, seven, eight, or nine elements. The term “subset” in relation to a group may thus describe a “proper subset” of the group, so that all the elements of the subset belong to the group, but at least one element of the group does not belong to the subset.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### List of reference signs

100a Circuit configuration
100b Circuit configuration
102a Light emitting diode
102b Light emitting diode
104a Supply terminal
104b Supply terminal
106a Switchable element
106b Switchable element
108a Current source
108b Current source
110b String of light emitting diodes
200 Circuit
202 Voltage sources
202-1 First voltage source
202-2 Second voltage source
202-3 Third voltage source
204 Voltage rails
204-1 First voltage rail
204-2 Second voltage rail
204-3 Third voltage rail
206 String of LEDs
206-2 String of LEDs
208 LED device
208-2 LED device
210 Input terminal
210-2 Input terminal
212 Current source
212-2 Current source
214 Reference terminal
214-2 Reference terminal
216 Switch arrangement
216-2 Switch arrangement
218 Switchable element
218-2 Switchable element
220 Switch circuit
220-1 First switch circuit
220-2 Second switch circuit
222 Control circuit
222-1 First control circuit
222-2 Second control circuit
300 Driver circuit
302 Supply terminal
304 Data terminals
306 Test terminals
308 Reference terminal
310 Digital processing circuit
312 Memory
314 Control signal
316 Reversal protection circuit
318 Overvoltage detection circuit
320 Power management circuit
322 Temperature sensor
324 Thermal shutdown circuit
326 Control terminals
328 Switchable elements
330 LED control circuit
332 Current source
400 Circuit
402 Switch circuit
404 Switchable element
500 Circuit
502 Current control signal
502a Control signal
510 PWM signal
512 Low state
514 High state
600 Method
610 Method step
620 Method step

1. A circuit comprising:
a plurality of voltage sources,
wherein each voltage source of the plurality of voltage sources is configured to generate a respective voltage;
a plurality of voltage rails,
wherein each voltage rail of the plurality of voltage rails is coupled with a respective voltage source of the plurality of voltage sources;
a plurality of strings of light emitting diode, LED, devices,
wherein each string of LED devices comprises a plurality of LED devices connected in series with one another;
a switch circuit configured to selectively couple or decouple each string of LED devices with the voltage rails,
wherein, for each string of LED devices, the switch circuit is configured to allow a simultaneous coupling of the string of LED devices with each voltage rail of the plurality of voltage rails; and
a control circuit configured to, for each string of LED devices control the switch circuit to selectively couple the string of LED devices with one or more voltage rails of the plurality of voltage rails.

2. The circuit according to claim 1, further comprising:
a respective current source for each string of LED devices,
wherein the current source of a string of LED devices is connected in series to the LED devices of the string and is configured to generate a current and cause a flow of the generated current through the string of LED devices,
wherein the current source of a string of LED devices is a common current source for all the LED devices of the string of LED devices.

3. The circuit according to claim 2, further comprising:
a respective plurality of switchable elements for each string of LED devices,
wherein each switchable element is associated with a respective LED device of the respective string and is configured to selectively enable or disable a flow of current through the respective LED device, and
wherein the control circuit is configured to control the switch circuit as a function of a number of switchable elements that enable the flow of current through the respective LED device.

4. The circuit according to claim 3,
wherein, for each string of LED devices the control circuit is configured to control the switch circuit to selectively couple the string of LED devices to one or more of the voltage rails to deliver an increasing voltage at the string of LED devices for an increasing number of switchable elements that enable the flow of current through the respective LED device of that string.

5. The circuit according to claim 2,
wherein, for each string of LED devices, the control circuit is further configured to:
generate a pulse width modulation, PWM, signal to control a delivery of current from the respective current source to the string of LED devices,
control the current source using the generated PWM signal; and
control the switch circuit as a function of the generated PWM signal.

6. The circuit according to claim 5,
wherein, for each string of LED devices the control circuit is configured to control the switch circuit to selectively couple the string of LED devices to one or more of the voltage rails to deliver an increasing voltage at the string of LED devices for an increasing duty cycle of the generated PWM signal.

7. The circuit according to claim 1,
wherein the plurality of voltage sources comprises at least a first voltage source configured to generate a first voltage and a second voltage source configured to generate a second voltage,
wherein the first voltage is different from the second voltage.

8. The circuit according to claim 1,
wherein the control circuit comprises a plurality of control circuits each associated with a respective string of LED devices and configured to control the switch circuit to selectively couple the respective string of LED devices with one or more voltage rails of the plurality of voltage rails.

9. The circuit according to claim 1,
wherein the plurality of strings of LED devices comprise at least a first string of LED devices and a second string of LED devices, and
wherein the control circuit is configured to control the switch circuit to couple, at a same time point, the first string of LED devices with one or more voltage rails that deliver a voltage with a first voltage value, and the second string of LED devices with one or more voltage rails that deliver a voltage with a second voltage value,
wherein the first voltage value is different from the second voltage value.

10. The circuit according to claim 1,
wherein, for each string of LED devices the switch circuit comprises a respective plurality of switchable elements,
wherein each switchable element is associated with a corresponding voltage rail, and is configured to selectively connect or disconnect an electrically conductive path between the respective voltage rail and the respective string of LED devices.

11. A method of driving a plurality of strings of LED devices, the method comprising:
generating plurality of supply voltages, wherein the plurality of supply voltages are common to a plurality of string of LED devices,
wherein more than one supply voltage at a time is deliverable to each string of LED devices; and
for each string of LED devices of the plurality of strings of LED devices, selectively enabling a delivery of one or more of the generated supply voltages to that string of LED devices to define a respective voltage drop across the string of LED devices.

12. The method according to claim 11,
wherein generating the plurality of supply voltages comprises providing each of the generated supply voltages at a respective voltage rail of a plurality of voltage rails; and
wherein selectively enabling the delivery of one or more of the generated supply voltages to a string of LED devices comprises selectively coupling the string of LED devices with one or more voltage rails of the plurality of voltage rails.

13. The method according to claim 11,
wherein selectively enabling the delivery of one or more of the generated supply voltages to a string of LED devices comprises selectively enabling the delivery of one or more of the generated supply voltages as a function of a current flow through the string of LEDs; and/or
wherein selectively enabling the delivery of one or more of the generated supply voltages to a string of LED devices comprises selectively enabling the delivery of one or more of the generated supply voltages at a certain time point as a function of a number of LED devices that emit light at that time point.

14. A circuit comprising:
a plurality of voltage sources,
wherein each voltage source of the plurality of voltage sources is configured to generate a respective voltage;
a plurality of voltage rails,
wherein each voltage rail of the plurality of voltage rails is coupled with a respective voltage source of the plurality of voltage sources,
a string of light emitting diode, LED, devices connected in series with one another;
a switch circuit configured to selectively couple or decouple the string of LED devices with the voltage rails,
wherein the switch circuit is configured to allow a simultaneous coupling of the string of LED devices with each voltage rail of the plurality of voltage rails; and
a control circuit configured to control the switch circuit to selectively couple the string of LED devices with one or more voltage rails of the plurality of voltage rails.

15. The circuit according to claim 14, further comprising:
a current source connected in series to the LED devices and configured to generate a current and cause a flow of the generated current through the string of LED devices,
wherein the current source is a common current source for all the LED devices of the string of LED devices;
wherein the control circuit is further configured to:
generate a pulse width modulation, PWM, signal to control a delivery of current from the current source to the string of LED devices;
control the current source using the generated PWM signal; and
control the switch circuit as a function of the generated PWM signal.

16. The circuit according to claim 15,
wherein the control circuit is configured to control the switch circuit to selectively couple the string of LED devices to one or more of the voltage rails to deliver an increasing voltage at the string of LED devices for an increasing duty cycle of the generated PWM signal.

17. The circuit according to claim 14, further comprising:
a plurality of switchable elements,
wherein each switchable element is associated with a respective LED device and is configured to selectively enable or disable a flow of current through the respective LED device, and
wherein the control circuit is configured to control the switch circuit as a function of a number of switchable elements that enable the flow of current through the respective LED device.

18. The circuit according to claim 17,
wherein the control circuit is configured to control the switch circuit to selectively couple the string of LED devices to one or more of the voltage rails to deliver an increasing voltage at the string of LED devices for an increasing number of switchable elements that enable the flow of current through the respective LED device.

19. The circuit according to claim 14,
wherein the plurality of voltage sources comprise at least a first voltage source configured to generate a first voltage and a second voltage source configured to generate a second voltage,
wherein the first voltage is different from the second voltage.

20. The circuit according to claim 14,
wherein the switch circuit comprises a plurality of switchable elements,
wherein each switchable element is associated with a corresponding voltage rail, and is configured to selectively connect or disconnect an electrically conductive path between the respective voltage rail and the string of LED devices.
